(19) United States
(12) Patent Application Publication
(10) Pub. No.: US 2023/0415170 A1
(43) Pub. Date: Dec. 28, 2023

(54) SEPARATOR HAVING A REMOVABLE CENTRIFUGE CONTAINER

(71) Applicant: Bruno PREGENZER, Mieming (AT)

(72) Inventor: Bruno PREGENZER, Mieming (AT)

(21) Appl. No.: 18/248,833

(22) PCT Filed: Nov. 2, 2021
(86) PCT No.: PCT/EP2021/080295

§ 371 Date: Apr. 12, 2023

(30) Foreign Application Priority Data
Nov. 2, 2020 (AT) A50940/2020

(51) Int. Cl. B04B 7/04; B04B 11/06; B04B 1/02

(52) U.S. Cl. CPC B04B 7/04; B04B 11/06; B04B 1/02; A61C 19/00

(57) ABSTRACT

The invention relates to a separator for separating solids from a water mixture, the separator comprising: a housing having a lid; and a centrifuge basket which is rotatably mounted in a centrifuge chamber of the housing and can be driven in rotation. The housing has a mixture inlet for the waste water mixture to be separated, which inlet opens into the centrifuge chamber, and a liquid outlet for liquid separated from the waste water mixture. An overflow opening is formed between the upper side of the centrifuge basket and the housing such that, during the centrifugal process, liquid can flow from the centrifuge basket into an outlet chamber which is connected to the liquid outlet. According to the invention, the centrifuge basket is designed such that, after the centrifugal process, solids which sink under the effect of gravity remain in the centrifuge basket.

The present invention relates to a separator for separating solids from a waste water mixture, in particular a dental debris separator, for separating solids from a dental waste water mixture in accordance with the preamble of claim 1.

Such separators are used, for example, in the dental sector and serve the separation of the liquid/solid mixture originating from a dental suction device or from a cuspidor. The latter can in particular include amalgam particles that could develop a toxic effect in the environment due to the mercury they contain and that therefore have to be separated from the waste water mixture and be supplied to a special waste disposal. In this respect, for example, a separator with its associated suction machine is associated with a plurality of dental chairs (for example 5 dental chairs).

Such a dental debris separator is known, for example, from WO 92/18062. The separation of the solid particles from the liquid takes place here by means of a solid bowl centrifuge while the liquid overflowing from the centrifuge flows off via a liquid outlet. The solid particles having a residual liquid portion flow over a solid drain into a removable sedimentation container arranged below the centrifuge after every centrifuging phase. The sedimentation container is removed on a reaching of a specific filling level and is typically tightly closed and sent off for the purpose of disposal or recycling.

The present invention has now set itself the object of providing such a separator with a more compact design and of reducing the number of components coming into contact with potentially toxic substances.

This object is achieved in accordance with the invention by a device having the features of claim 1. Advantageous embodiments of the invention result from the dependent claims and from the following description.

A separator for the separation of solids from a waste water mixture, in particular a dental waste water mixture, that is in particular a dental debris separator, is accordingly proposed that comprises a housing having a cover and a centrifuge drum that is rotatably mounted in a centrifuge chamber of the housing and is rotationally drivable. The housing has a mixture inlet for the waste water mixture to be separated opening into the centrifuge chamber and a liquid outlet for liquid separated from the waste water mixture. An overflow opening is formed here between the upper side of the centrifuge drum and the housing such that liquid can move from the centrifuge drum into an outlet chamber connected to the liquid outlet during the centrifuging process.

In accordance with the invention, the centrifuge drum is configured such that settling or separating solids remain in the centrifuge drum due to the effect of gravity after a centrifuging process. The centrifuge drum can be exposed by opening the cover of the housing, with the centrifuge drum being able to be dismantled or removed from the housing with the solids collected therein remaining.

The idea in accordance with the invention is therefore no longer to collect the separated solid particles in a separate container, but rather directly in the centrifuge drum and to configure the separator in accordance with the invention such that the full centrifuge drum can be dismantled and removed from the housing. The number of parts that come into contact with the waste water mixture or its components is thereby reduced to a minimum. The removed centrifuge drum can subsequently be directly supplied to further processing or disposal, for example in that the drum is closed by a lid and is sent off.

The centrifuge drum is preferably a centrifuge container that is configured as a solid bowl centrifuge and that is in particular set into rotation via a motor unit so that the solids such as amalgam particles contained in the waste water mixture are pressed onto the inner wall due to the centrifugal force while the liquid can move into the outlet chamber over the overflow opening. A solid/liquid separation is thereby achieved. The centrifuge chamber is in particular a hollow space that is formed within the (closed) housing and in which the centrifuge drum is rotatably mounted.

The overflow opening formed above the centrifuge drum can be considered as part of the centrifuge chamber, but in particular extends radially outwardly over the preferably substantially cylindrical centrifuge chamber and forms a connection to the outlet chamber. The latter can represent a substantially ring-shaped or peripheral chamber from which a connector for the liquid drainage starts. The outlet chamber can have a slanted or chamfered base so that the liquid collecting therein flows independently into the liquid outlet. The latter can start tangentially from the outlet chamber. The outlet chamber is in particular rotationally rigid, as is the centrifuge chamber and the overflow opening.

The centrifuge drum can be conical, i.e. can widen upwardly toward the overflow opening to facilitate a discharge of the liquid. Alternatively or additionally, the centrifuge drum can have a retention device or a liquid capture device, in particular arranged in the upper region of the centrifuge drum, that can, for example, be configured as a peripheral and downwardly facing web. It is thereby prevented that solids can exit the centrifuge drum from above during a rotation. Only when the liquid layer forming at the inner wall of the centrifuge drum has reached a certain thickness or intensity does liquid flow over the liquid capture device into the overflow opening while the solids remain in the centrifuge drum.

Provision is made in an embodiment that a plurality (i.e. at least two) of separating blades or separating vanes are arranged preferably distributed over the periphery at the centrifuge drum in the region of the overflow opening and are configured to hurl the liquid exiting the centrifuge drum from above during the centrifuging process outwardly in the direction of the outlet chamber. The separating blades therefore rotate with the centrifuge drum and act as a kind of pump that hurls the separated liquid outwardly that flows between the separating blades. The separating blades in particular serve the overcoming of a vacuum when a vacuum is used to suck off air in the centrifuge drum so that the liquid can move into the outlet chamber. The separating blades are in particular evenly distributed over the periphery.

Provision is made in a further embodiment that the separating blades are formed or attached at a flange that is fixedly or releasably connected to an upper margin of the centrifuge drum and that preferably have a swept form. The flange preferably projects radially outwardly at the upper end of the centrifuge drum and is in particular at least partially arranged in a gap that is formed between the outlet chamber and the centrifuge chamber and that is part of the overflow opening. When the flange is releasably connected to the centrifuge drum, it can in particular be removed on the dismantling of the filled centrifuge drum and can be attached to the centrifuge drum that is to be installed as new. Alternatively, the flange can also be fixedly connected to the centrifuge drum and can be dismantled/sent off together therewith.

Provision is made in a further embodiment that the flange has a web that runs around in the peripheral direction and that runs in a groove formed between the outlet chamber and the centrifuge chamber, with the web and the groove preferably forming a labyrinth seal or being a part of such. The web and the groove are in particular circular viewed from above and run around the centrifuge chamber that is equally circular in a plan view. The web rotates with the centrifuge drum and slides in the groove. A part of the outer wall of the centrifuge drum can likewise be part of the labyrinth seal, just like any further sealing elements or webs/grooves. An ideal sealing is achieved by the labyrinth seal at the margin of the in particular tangential liquid outflow or the liquid discharge at the centrifuge drum.

A sealing element that is in particular peripheral or of ring or ribbon shape, that separates the outlet chamber from the mixture inlet in an airtight manner, and that has at least one valve element for the liquid/air separation is provided in a further embodiment. The at least one valve element is preferably configured to permit a passage of liquid and to prevent or block a passage of air, in particular in combination with a vacuum that is present in an inner region or inner volume sealed by the sealing element. The sealing element enables an effective liquid/air separation.

Provision is made in a further embodiment that the sealing element is arranged in the region of the overflow opening and separates the outlet chamber from the centrifuge chamber in an airtight manner, with the valve element preferably being configured to permit a passage of liquid exiting the centrifuge drum into the outlet chamber during the centrifuging process. In this respect, the liquid is in particular hurled toward the sealing element by means of the previously mentioned separating blades that rotate along with the centrifuge drum. The valve element in particular prevents a passage of air in combination with a vacuum present in the centrifuge drum. The sealing element in particular extends in ring shape about the centrifuge chamber or centrifuge drum.

A vacuum can be generated in the inner volume that is sealed by the sealing element, which here does not include the inner space of the centrifuge drum and, preferably, at least a portion of the overflow opening, via an air suction device that can be connected to the centrifuge chamber via an air outlet. The sealing element is designed such that no air can penetrate from the outside. The separation of solids takes place here within the volume in which the vacuum is present.

Provision is made in an alternative embodiment that the sealing element is arranged in the region of a mixture distributor rotatably mounted within the centrifuge drum and in particular rotationally drivable and separates the outlet chamber from the mixture distributor in an airtight manner. The valve element is preferably configured to permit a passage of liquid exiting the mixture distributor during the centrifuging process. The mixture distributor can be configured as an impeller having a plurality of separating blades that centrifuge the waste water mixture entering into the housing from the mixture inlet outwardly and toward the sealing element. In this case, the sealing element is therefore arranged within the centrifuge drum and in particular extends in ring form about the mixture distributor.

A vacuum can be generated in the inner volume sealed by the sealing element, which in this alternative case includes the opening region of the mixture inlet and of the mixture distributor, via an air suction device that can be connected to the centrifuge chamber via an air outlet. The sealing element is designed such that no air can penetrate from the outside. The separation of solids takes place here outside the volume in which the vacuum is present.

Provision is made in a further embodiment that the sealing element is produced at least sectionally from an elastic material, in particular rubber, with the valve units being formed by valve flaps or valve flap-like openings that can be reversibly outwardly deflected by the liquid passing through and that are preferably formed in one piece in the elastic material. In the simplest case, the valve flaps are formed by incisions into the elastic material. They are bent outwardly by the liquid hurled toward the sealing element (either by the separating blades at the upper margin of the centrifuge drum or by the mixture distributor) and allow liquid to pass through. The valve flaps are independently closed and sealed again, in particular against a vacuum present in the interior, due to the return force of the elastic material so that an airtight seal is created. Provision can be made that the total sealing element consists of the elastic material and is, for example, formed as a rubber ring or that only individual regions, for example the valve flaps, consist of the elastic material.

Provision is made in a further embodiment that the sealing element contacts a separating web that is arranged in the region of the overflow opening, that is arranged between the sealing element and the centrifuge chamber, and in which passage openings respectively associated with a valve flap are formed. The separating web therefore likewise has a plurality of (i.e. at least two) openings or windows. The separating web can be formed in one piece with the housing, in particular with the housing cover, or can be a separate component that is mounted or installed in/at the housing. The separating web can simultaneously serve the fixing of the sealing element, for example in that it is arranged at the housing cover and clamps a portion of the sealing element, for example a peripheral fastening lip, on the closing of the cover. The passage openings are preferably smaller than the valve flaps so that the latter cannot open inwardly and can thereby allow air to flow in from the outside. The valve flaps are thereby pressed from the outside toward the separating web on an internally present vacuum and on the absence of outwardly pressing liquid and seal the inner space against the outlet chamber in an airtight manner.

Provision can alternatively be made that the sealing element outwardly contacts a distributor housing that surrounds the mixture distributor and that has corresponding passage openings, as previously described.

Provision is made in a further embodiment that the housing has an air outlet that opens into the centrifuge chamber and through which air can be sucked from the centrifuge drum and/or from the overflow opening, for example by means of an air suction device connected to the air outlet, and that is preferably arranged centrally above the centrifuge drum and/or in the region of the mixture inlet. A separation of solids, liquid, and air of a three-phase waste water mixture is thus possible.

Provision is made in a further embodiment that a mixture distributor is rotatably supported within the centrifuge drum and is rotationally drivable, with the mixture distributor being configured to distribute the waste water mixture exiting the mixture inlet in the centrifuge drum and/or to hurl it toward its inner wall, and with the mixture distributor preferably being rotationally drivable together with the centrifuge drum. The mixture distributor can likewise be dismantlable for the dismantling of the centrifuge drum. The mixture distributor can comprise a plastic.

Provision is made in a further embodiment that the mixture distributor is configured as an impeller that has a plurality of in particular swept separating blades or separating vanes and that preferably has a conical form that in particular widens downwardly in the direction of the centrifuge drum seen from the side. The impeller preferably has a round shape in a plan view.

Provision is made in a further embodiment that the mixture distributor comprises at least one continuous air channel and is arranged in the region of the opening of the air outlet such that the air sucked in from the centrifuge drum flows through the at least one air channel into the air outlet, with the at least one air channel preferably extending substantially in parallel with the axis of rotation of the mixture distributor. A plurality of air channels can be provided that, for example, extend at least partially between a plurality of separating blades. The separating blades can therefore, on the one hand, serve the distribution of the waste water mixture and, on the other hand, the sucking in of air. Alternatively or additionally, air channels can be formed that are specifically provided for the air removal. The mixture distributor can be arranged directly at/in the air outlet.

Provision is made in a further embodiment that the mixture distributor is at least partially surrounded by a distributor housing that is rotationally fixedly connected to the housing and that is connected to the air outlet and/or the mixture inlet. The distributor housing preferably directly adjoins the air outlet and/or the mixture inlet and preferably has a conical shape that in particular follows the outer contour of the mixture distributor. The air removal can be arranged centrally and the mixture inlet can be arranged around the air outlet. The waste water mixture is thereby conducted to the outer region of the mixture distributor at which in particular a plurality of separating blades are located while the air is sucked in from the inner space of the centrifuge drum via the inner/central region of the mixture distributor. The distributor housing is preferably open toward the base of the centrifuge drum, but can also be otherwise configured and e.g. have lateral openings.

Provision is made in a further embodiment that the centrifuge drum and the mixture distributor are rotationally drivable via a common shaft rotatably mounted in the housing and preferably led through a cutout formed in the base of the centrifuge drum. The shaft is preferably drivable by a motor. The shaft is furthermore guided through a cutout in the housing and is in particular sealed with respect thereto. The mixture distributor can be connected to the shaft by a releasable connection, for example via at least one screw, and can be separable or removable therefrom for the removal of the centrifuge drum.

Provision is made in a further embodiment that a drum cover is provided by means of which the centrifuge drum removed from the housing can be closed, in particular closed in a gastight and/or liquid tight manner. After the removal of the centrifuge drum filled with separated solids from the housing, the stored drum cover is placed onto the centrifuge drum and is, for example, fixedly screwed (other kinds of fastening are naturally also conceivable here) so that the solids are securely stored in the centrifuge drum and the closed and sealed centrifuge drum can be sent off or transported for the purpose of disposal.

Provision is made in a further embodiment that the mixture inlet, the outlet chamber, the centrifuge chamber, the centrifuge drum, the housing cover, and/or the mixture distributor are arranged coaxially with one another. For the outlet chamber, for example, this means that it can run around the centrifuge chamber in ring form, with the geometric center of the circular chamber lying on the axis of rotation of the centrifuge drum. A compact design of the separator in accordance with the invention thereby results.

Further features, details, and advantages of the invention result from the embodiment explained in the following with reference to the Figures. There are shown:

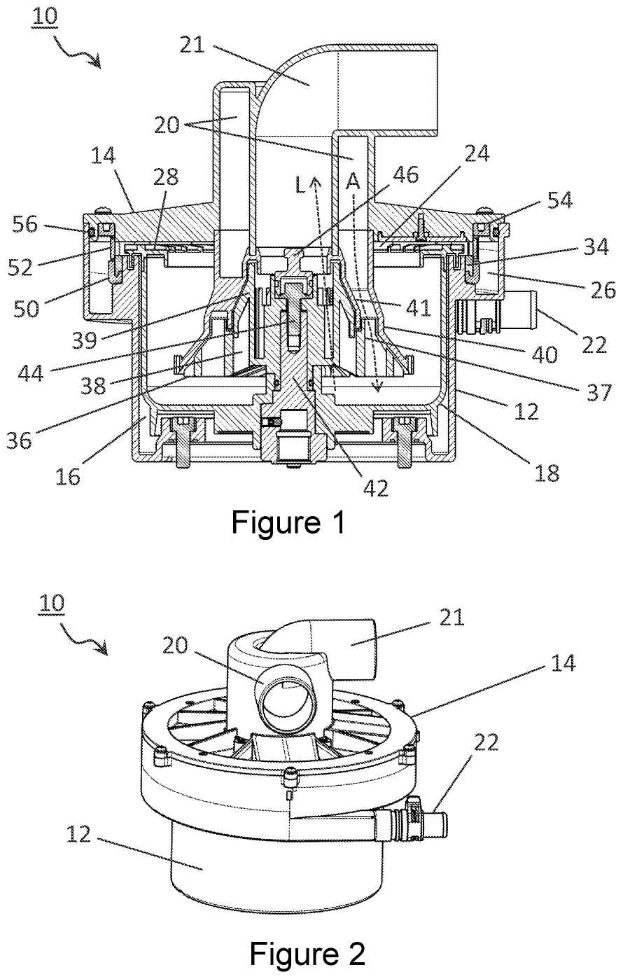

FIG. 1: a side sectional view of the separator in accordance with the invention in accordance with a preferred embodiment;

FIG. 2: the separator of FIG. 1 in a perspective view;

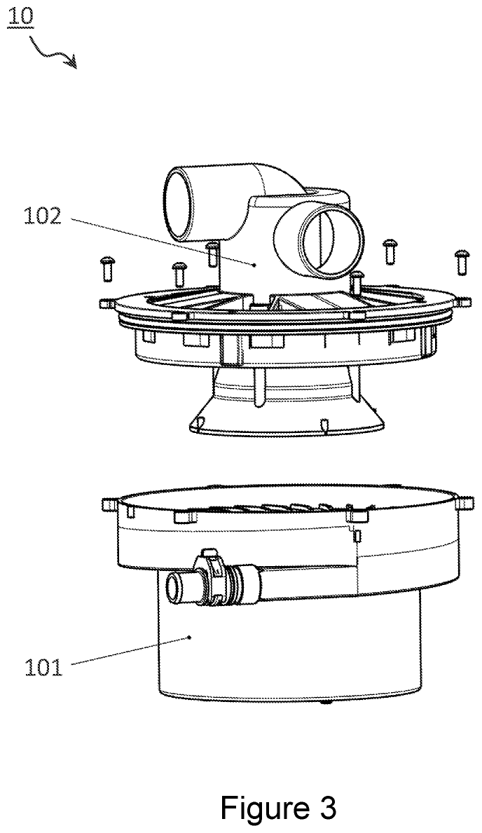

FIG. 3: an upper and lower part of the separator of FIG. 2 in a perspective view;

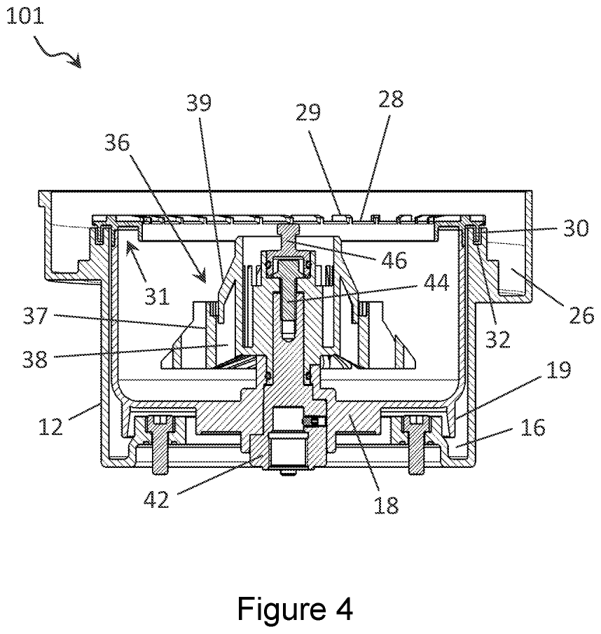

FIG. 4: a side sectional view of the lower part;

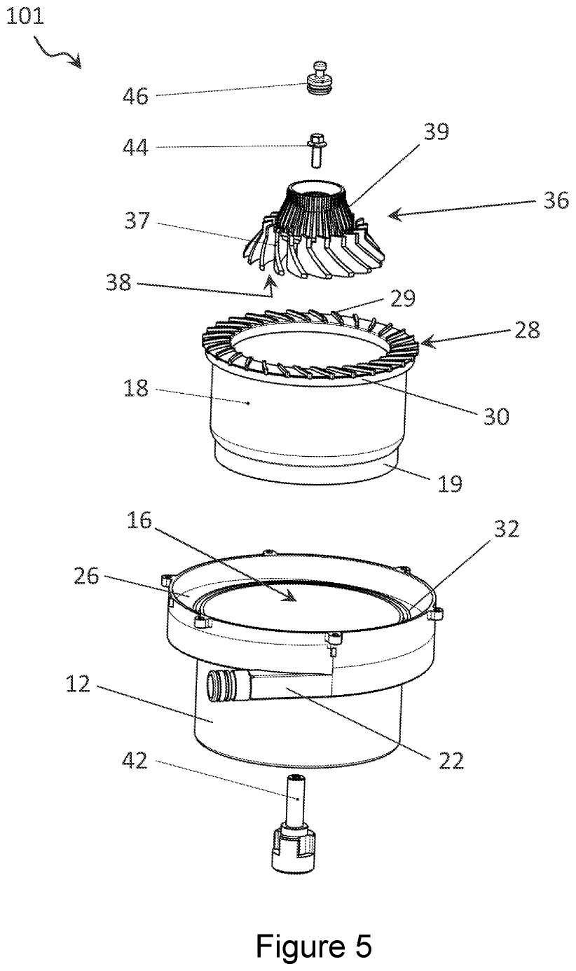

FIG. 5 a perspective exploded representation of the lower part; and

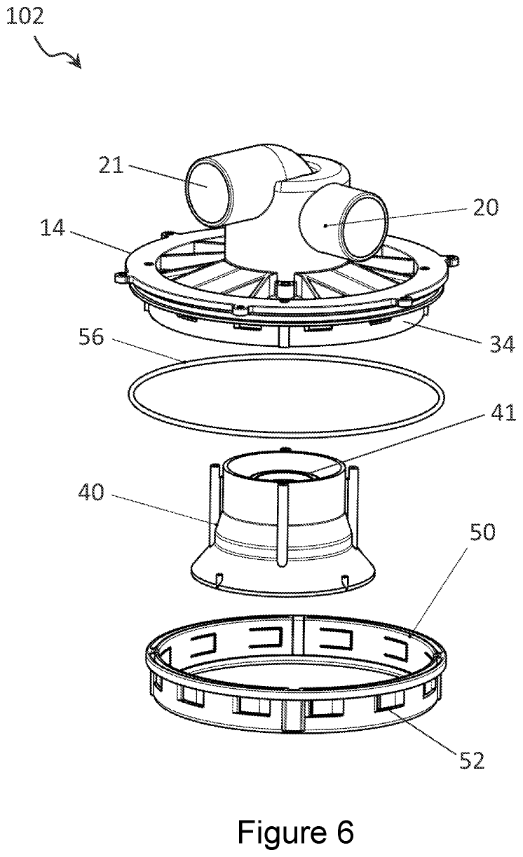

FIG. 6: a perspective exploded view of the upper part.

FIG. 1 shows a central section through an embodiment of the separator 10 in accordance with the invention in a side view. A perspective view of the total separator 10 is shown from the outside in FIG. 2. As is shown in FIG. 3, the separator 10 is divisible into two assemblies: a lower part 101 and an upper part 102. FIGS. 4 and 5 show a lateral sectional view and an exploded view through the lower part 101 while an exploded view of the upper part 102 is shown in FIG. 6.

The terms “up” and “down” used here relate to the case that the separator 10 is placed on a planar surface or is in a planar installation location and is therefore oriented as shown in FIG. 1.

The separator 10 in accordance with the invention has a housing 12 within which a substantially cylindrical centrifuge chamber 16 is formed. A centrifuge drum 18 (also called a centrifuge container) formed as an upwardly open solid bowl centrifuge is present in the centrifuge chamber 16. The centrifuge drum 18 is rotationally fixedly connected to a shaft 42 that is rotatably mounted in the housing 12 and that is rotationally drivable via a motor unit not shown in any more detail here, with the shaft 42 being led through the housing 12 from below. The upper part of the housing 12 forms a cover 14 that is connected to a lower housing part via a plurality of screws and that is thus removable. The seal between the lower housing part and the cover 14 takes place via a sealing element 56 formed as an O ring (cf. FIGS. 1 and 6).

A mixture distributor 36 that is formed from an impeller having a plurality of swept separating blades 37 and is rotationally fixedly connected to the shaft 42 is located within the centrifuge drum 18. The centrifuge drum 18 and the impeller 36 thus rotate together with the shaft 42. A mixture inlet 20 is located above the impeller 36; it is a mixture inlet 20 via which the waste water mixture to be separated, which is in particular a dental waste water mixture, is introduced into the centrifuge drum centrally from above. The mixture inlet 20 opens into a distributor housing 40 that is rotationally fixedly fastened to the cover 14, that is open toward the base of the centrifuge drum 18, and that surrounds the rotatable impeller 36. Both the impeller 36 and the distributor housing 40 have a form that widens toward the bottom and that is substantially conical viewed from the side, with the inner contour of the distributor housing following the outer contour of the impeller 36.

As can easily be recognized in the exploded representation of FIG. 5, the impeller has a plurality of separating blades or separating vanes 37 that are evenly distributed over the periphery, that start radially from the axis of rotation, and that are laterally swept. A conical region 39 that extends within a correspondingly shaped inner wall 41 of the distributor housing is located above the separating blades 37. The inner wall 41 here does not extend up to the lower end of the distributor housing 40 and forms a peripheral gap that is connected to the mixture inlet 20 with the outer wall of the distributor housing 40. The inflowing waste water mixture flows from above during the centrifuging process (that is when the impeller 36 and the centrifuge drum 18 rotate) from the mixture inlet 20 into the gap between the inner wall 41 and the outer wall of the distributor housing 40 and subsequently through the intermediate spaces formed between the separating blades 37 (cf. the dashed arrow A in FIG. 1). Since the impeller 36 rotates fast, the waste water mixture is distributed and hurled downwardly/outwardly toward the inner wall of the centrifuge drum 18.

An air outlet 21 that is surrounded by the mixture inlet 20 and that likewise opens into the distributor housing 40 is furthermore located above the impeller 36. Air can be sucked out of the interior of the housing 12, i.e. of the centrifuge chamber 16 or the inner space of the centrifuge drum 18 via the air outlet 21 and thus separated from the waste water mixture by means of an air suction device not shown here. The air outlet 21 is connected to the inner wall 41 so that the air is sucked out via air channels 38 extending within the inner wall 41 (cf. the dashed arrow L in FIG. 1). These air channels 38 are formed by intermediate spaces of separating blades 37 that extend from the inside to the outside below the conical region 39. Liquid being sucked into the air outlet 21 is prevented by the rotation of the impeller 36 and the separation of the region of the inner air removal L from the region of the outer waste water mixture flow A by means of the inner wall 41 of the distributor housing 40. As can be recognized in FIG. 2, the mixture inlet 20 and the air outlet 21 have lateral connectors to which e.g. tubes can be connected.

During the centrifuging process, the waste water mixture distributed via the impeller 36 in the centrifuge drum 18 is pressed toward the inner wall of the centrifuge drum 18 due to the centrifugal force. In this respect, the solid components or solid particles of the waste water mixture remain at the inner wall while the liquid exits the centrifuge drum 18 from above and moves via an overflow opening 24 into an outlet chamber 26 running around the centrifuge chamber 16. The outlet chamber 26 is connected to a tangential liquid outlet 22 (cf. FIG. 2), with the liquid collecting in the outlet chamber 26 flowing into the liquid outlet 22 due to a slanting of the base. A suitable tube can be connected thereto. After every centrifuging process, the solid particles fall downward due to gravity (and the now no longer active centrifugal force) and collect at the base of the centrifuge drum 18. A three-phase separation of the upwardly centrally inflowing waste water mixture therefore takes place overall by means of the centrifuge.

As can in particular easily be recognized in FIGS. 4 and 5, a flange 28 that has a plurality of separating blades or separating vanes 29 that are evenly distributed over the periphery at its upper side and that are swept or bent to the side is located at the upper side of the centrifuge drum 18. The flange 28 here projects radially inwardly and closes with a downwardly facing peripheral web that forms a liquid capture device 31. The liquid capture device 31 provides that the solid particles (with a small amount of liquid) pressed toward the inner wall of the centrifuge drum 18 move upwardly out of the centrifuge drum 18. Only when a sufficiently strong liquid film has formed at the inner wall of the centrifuge drum 18 that goes beyond the width of the liquid capture device 31 does liquid exit the centrifuge drum 18 from above. The wholly outwardly located solid particles thereby always remain in the centrifuge drum 18.

The flange 28 likewise projects radially outwardly from the upper side of the centrifuge drum 18 and there has a downwardly facing peripheral web 30 that extends within an upwardly open, likewise peripheral groove 32 of the housing 12 (cf. FIG. 4). The wall of the centrifuge drum 18, the web 30, and the groove 32 form a labyrinth seal that seals the centrifuge drum 18 toward the housing 12 or the outlet chamber 26. Further sealing elements can be provided here to further increase the sealing effect.

A small gap remains between the upper side of the flange 28 and the housing cover 14 and is part of an overflow opening 24 that continues as a gap running around the centrifuge chamber up to the outlet chamber 26. The separating blades 29 of the flange 28 move in this gap. The liquid exiting upwardly from the centrifuge drum 18 is urged between the separating blades 29 and is hurled outwardly therethrough in the direction of the outlet chamber 26 due to the rotation of the flange 28 together with the centrifuge drum 18.

A ribbon-like or ring-like peripheral sealing element 50, that is arranged at the end of the overflow opening 24 at the outlet chamber side, is located between the centrifuge chamber 16 and the outlet chamber 26. The sealing element 50 that can easily be recognized in FIG. 6 consists of rubber in this embodiment and has a plurality of rectangular valve flaps 52 that are evenly distributed over the periphery and are formed by (angular) U-shaped incisions in the rubber. The upper margin of the sealing element 50 is seated in a downwardly open peripheral groove 54 in the housing cover 14 while the lower margin has a hook-like fastening lip bent in the direction of the centrifuge drum 18.

A peripheral separating web 34 connected to the housing cover 14 is arranged between the sealing element 50 and the flange 28 and contacts the inner side of the sealing element 50. The separating web 34 engages into the fastening lip of the sealing element 50 and clamps it in the housing 12. The sealing element 50 is therefore fixed in the housing 12 via the separating web 34. The separating web 34 furthermore has a plurality of openings or windows evenly distributed over the periphery, with a respective window being associated with valve flap 52. The windows are in particular rectangular and smaller than the valve flap-like openings or valve flaps 52 and can be recognized sectionally in FIG. 6.

Since the air is sucked from the interior of the housing 12 via the air outlet 21, a vacuum is present in the inner volume located in the sealing element 50. The valve flaps 52 are pressed from the outside toward the separating web 34 by this vacuum so that the passage openings or windows formed therein are closed in an airtight manner. The liquid separated from the waste water mixture is hurled from the inside toward the valve flaps 52 by the separating blades 29 of the flange 28 during the centrifuging process. The separating blades 29 thus act as a kind of auxiliary pump so that the separated liquid can overcome the vacuum and move into the outlet chamber 26

The valve flaps 52 bend outwardly in the direction of the outlet chamber 26 due to their elasticity and enable a passage of the liquid from the overflow opening 24 into the outlet chamber 26. However, no air can escape outwardly here or can move from the outside to the inside since the valve flaps 52 are immediately closed again due to the return force of the rubber as soon as liquid no longer presses against it from the inside. On the passage of the liquid, it seals the opened valve flaps 52 in an airtight manner itself. The sealing element 50 thus enables a simple, effective, and inexpensive liquid/air separation.

The housing cover 14 can be removed from the lower part of the housing 12, whereby the centrifuge drum 18 and the impeller 36 mounted therein are exposed. As can be seen in FIG. 3, the separating web 34, the sealing element 50, and the valve housing 40 are fastened to the cover 14. Before the centrifuge drum 18 can be dismantled, the impeller 36 has to be removed that is fastened to the shaft 42 by means of a screw 44 (cf. FIGS. 3 and 4). The screw 44 is covered by means of a cover cap 46 and enables a simple and fast removal of the impeller 36 from the centrifuge drum 18. The centrifuge drum 18 can subsequently be taken out of the housing 12 and can be closed by means of a drum cover not shown here. The flange 28 is furthermore removed from the centrifuge drum 18 and can, for example, be placed onto a centrifuge drum 18 to be inserted as new. An embodiment is, however, also conceivable in which the flange 28 is fixedly connected to the centrifuge drum 18 and is sent off together with it. To be able to place the removed centrifuge drum 18 down in a stable manner, it has a support foot 19 formed as a peripheral web at the lower side.

In the separator 10 in accordance with the invention, the solids separated from the waste water mixture is thus not collected in a separate collection container or sedimentation container, but rather collect within the centrifuge drum 18 after the separation. When a certain filling level (that can be determined by means of a sensor device, for example) is reached, the centrifuge drum 18 is removed and closed, as described above, so that it can be supplied to a further processing or disposal. Unlike customary systems, the carcass of the separating device therefore itself serves the collection and disposal of the separated solid particles in the separator 10 in accordance with the invention. In addition, high volume flows can be processed using the three-phase separation system shown here, for example volume flows of up to 20 l/min. High degrees of separation can be achieved by a correspondingly large dimensioning of the unit.

In an alternative embodiment, the sealing element 50 is not arranged between the outlet chamber 26 and the centrifuge drum 18, as described above, but is rather outwardly disposed at the distributor housing 40 (or at a component connected to the distributor housing 40). In this case, the vacuum generated by the air suction device is only present within the distributor housing 40 that is downwardly closed unlike the previously described embodiment. The separation of the solid components of the waste water mixture from the liquid phase takes place outside the volume closed in an airtight manner by the sealing element 50, that is outside the region of the vacuum. The deflection of the valve flaps 52 that enable a passage of the waste water mixture (that is of the liquid/solid phase) takes place in this embodiment by the impeller 36 that rotates within the sealing element 50 and that hurls the waste water mixture toward the valve flaps 52. As described above, the return force of the valve flaps 52 prevents air from moving from outside the sealing element 50 into the inner region of the distributor housing 40 or into the air outlet 21.

In this alternative embodiment, separating blades running along with the centrifuge drum 18 are not absolutely required that hurl the liquid in the direction of the outlet chamber 26. Provision can thus be made that the liquid separated from the solid particles exits directly from above from the centrifuge drum 18 and moves into the outlet chamber 26 via the overflow opening 24.

### REFERENCE NUMERAL LIST

10 separator
12 housing
14 cover
16 centrifuge chamber
18 centrifuge drum
19 support foot
20 mixture inlet
21 air outlet
22 liquid outlet
24 overflow opening
26 outlet chamber
28 flange
29 separating blade
30 web
31 liquid capture device
32 groove
34 separating web
36 mixture distributor (impeller)
37 separating blade
38 air channel
39 conical region
40 distributor housing
41 inner wall
42 shaft
44 screw
46 cover cap
50 sealing element
52 valve unit (valve flap)
54 groove
56 sealing element
101 lower part
102 upper part
A flow direction of waste water mixture
F flow direction of air

1. A separator for separating solids from a waste water mixture, comprising a housing having a cover and a centrifuge drum rotatably mounted in a centrifuge chamber of the housing and rotationally drivable, wherein the housing has a mixture inlet opening into the centrifuge chamber for the waste water mixture to be separated and a liquid outlet for liquid separated from the waste water mixture, and wherein an overflow opening is formed between the upper side of the centrifuge drum and the housing such that liquid from the centrifuge drum can move from the centrifuge drum into an outlet chamber connected to the liquid outlet during the centrifuging process,
wherein
the centrifuge drum is configured such that after a centrifuging process, solids sinking under the effect of gravity remain in the centrifuge drum, with the centrifuge drum being able to be exposed by opening the cover and being removable from the housing with the solids remaining therein.

2. A separator in accordance with claim 1, wherein a plurality of separating blades are arranged distributed over the periphery at the centrifuge drum in the region of the overflow opening and are configured to hurl the liquid exiting the centrifuge drum from above during the centrifuging process outwardly in the direction of the outlet chamber.

3. A separator in accordance with claim 2, wherein the separating blades are formed or attached at a flange fixedly or releasably connected to an upper margin of the centrifuge drum and that preferably have a swept form.

4. A separator in accordance with claim 3, wherein the flange has a web that runs around in the peripheral direction and that runs in a groove formed between the outlet chamber and the centrifuge chamber, with the web and the groove forming a labyrinth seal or being a part of such.

5. A separator in accordance with claim 1, wherein a sealing element, is provided that separates the outlet chamber from the mixture inlet in an airtight manner and has at least one valve element for the liquid/air separator, with the valve element being configured to permit a passage of liquid and to prevent a passage of air, in combination with a vacuum present in an inner region sealed by the sealing element.

6. A separator in accordance with claim 5, wherein the sealing element is arranged in the region of the overflow opening and separates the outlet chamber from the centrifuge chamber in an airtight manner; or in that the sealing element is arranged in the region of a mixture distributor rotatably mounted within the centrifuge drum and separates the outlet chamber from the mixture distributor in an airtight manner, with the valve element being configured to permit a passage of liquid exiting the centrifuge drum or the mixture distributor during the centrifuging process.

7. A separator in accordance with claim 6, wherein the sealing element is produced at least sectionally from an elastic material with the valve units being formed by valve flaps that can be reversibly outwardly deflected by the liquid passing through and that are formed in one piece in the elastic material.

8. A separator in accordance with claim 7 wherein the sealing element contacts a separating web arranged in the region of the overflow opening between the sealing element and the centrifuge chamber or a distributor housing that surrounds the mixture distributor and in which passage openings associated with a respective valve flap are formed, with the passage openings being smaller than the valve flaps.

9. A separator in accordance with claim 6, wherein the housing has an air outlet that opens into the centrifuge chamber, through which air can be sucked from the region of the mixture inlet, the centrifuge drum, and/or the overflow opening and which is arranged centrally above the centrifuge drum and/or in the region of the mixture inlet.

10. A separator in accordance with claim 1, wherein a mixture distributor is rotatably supported within the centrifuge drum and is rotationally drivable, with the mixture distributor being configured to distribute the waste water mixture exiting the mixture inlet in the centrifuge drum and/or to hurl it toward its inner wall, and with the mixture distributor being rotationally drivable together with the centrifuge drum.

11. A separator in accordance with claim 6, wherein the mixture distributor is configured as an impeller having a plurality of separating blades, said impeller having a conical form viewed from the side.

12. A separator in accordance with claim 9, wherein the mixture distributor comprises at least one continuous air channel and is arranged in the region of the opening of the air outlet such that the air sucked in from the centrifuge drum flows through the at least one air channel into the air outlet, with the at least one air channel extending in parallel with the axis of rotation of the mixture distributor.

13. A separator in accordance with claim 12, wherein the mixture distributor is at least partially surrounded by a distributor housing that is rotationally rigidly connected to the housing and that is connected to the air outlet and/or the mixture inlet and is open toward the base of the centrifuge drum.

14. A separator in accordance with claim 13, wherein the centrifuge drum and the mixture distributor are rotationally drivable via a common shaft rotatably mounted in the housing led through a cutout formed in the base of the centrifuge drum.

15. A separator in accordance with claim 1, wherein a drum cover is provided by means of which the centrifuge drum removed from the housing can be closed.
